(19) United States
(12) Patent Application Publication
(10) Pub. No.: US 2015/0180039 A1
(43) Pub. Date: Jun. 25, 2015

(54) Sustainable Current Collectors for Lithium Batteries

(71) Applicant: Lifesize AB, Uppsala (SE)

(72) Inventors: John Oswald Thomas, Uppsala (SE); Michel Bernard Armand, Saint Martin d'Uriage (FR)

(21) Appl. No.: 14/417,305

(22) PCT Filed: Jul. 11, 2013
(86) PCT No.: PCT/SE2013/050891

§ 371 Date: Jan. 26, 2015

(30) Foreign Application Priority Data
Jul. 26, 2012 (SE) 1250899-0

(51) Int. Cl. H01M 4/66; H01M 10/054; H01M 4/75; H01M 4/587; H01M 4/60; H01M 4/485; H01M 4/38; H01M 4/525; H01M 4/505; H01M 4/58; H01M 10/0568; H01M 10/0565; H01M 10/0567; C25D 3/20; C25D 7/06; H01M 4/04; H01M 10/0569; B22F 3/02; B22F 3/12; B22F 3/18; B22D 23/00; B23K 20/00; B22F 5/00; H01M 10/0525

(52) U.S. Cl. CPC H01M 4/661; H01M 10/0525; H01M 10/054; H01M 4/75; H01M 4/667; H01M 4/587; H01M 4/60; H01M 4/485; H01M 4/38; H01M 4/381; H01M 4/525; H01M 4/505; H01M 4/5825; H01M 4/582; H01M 10/0568; H01M 10/0565; H01M 10/0567; C25D 3/20; C25D 7/0614; H01M 4/0452; H01M 4/0485; H01M 4/0471; H01M 4/043; H01M 10/0569; B22F 3/02; B22F 3/12; B22F 3/18; B22D 23/003; B23K 20/002; B22F 5/00; H01M 2300/0028; H01M 2300/0085; H01M 2300/0037

(57) ABSTRACT

The claimed invention relates to a current collector product for one or more galvanic battery cells. Currently, the metal considered as current collector for the negative electrode is copper. Some of the disadvantages of copper are that it is a rare, heavy and expensive element. To alleviate at least some of the problems of the prior art battery cells, at least part of the current collector electrode supporting portion is composed of pure iron or an iron alloy with less than 10 percent by weight of impurities or alloying constituents. The claimed invention also relates to a galvanic, lithium or sodium, battery cell and to a method for producing a current collector product.

### TECHNICAL FIELD

The present invention relates to galvanic, electrochemical battery cells, in particular lithium battery cells and sodium battery cells. The invention also relates to a current collector product, and to a method of producing a current collector product.

### PRIOR ART

Lithium batteries are currently the favourite contenders for electrical energy storage, especially for electric transportation and possibly load-levelling applications. State-of-the-art lithium-ion batteries have a negative electrode composed of carbon, such as graphite, hard or soft carbon or their mixtures. Silicon is actively studied, as well as tin, as it forms alloys with very high lithium content Li_{4.4}X (X═Si, Sn) that could substitute for carbon. By nature, a lithium-ion battery is built in the discharged state. All the lithium that will be shuttled during battery operation comes from the positive electrode. A fraction between 10 and 25% of this lithium is lost after the first charge, being consumed to build the SEI (Solid Electrolyte Interface), destined to protect the surface of the negative electrode from further corrosion.

In all cases, the sole metal considered as current collector for the negative electrode is copper. Aluminium cannot be used since, at the potentials where carbon, silicon or tin operate, it forms instead a lithium-aluminium alloy below 330 mV vs. Li⁺:Li° resulting in large volume expansion and fragmentation of the foil. Some of the disadvantages of copper are that it is a rare and expensive element and, because of its specific gravity of 8.94 g·cm⁻³, 10-20% of the battery weight is due to the negative electrode current collector. On overdischarge of the battery, copper easily dissolves, followed by copper dendrite formation when the current is reversed, leading to local heating and possible thermal runaway.

### SUMMARY OF THE INVENTION

One objective of the present invention is to alleviate at least some of the problems of the prior art battery cells.

According to a first aspect of the invention this objective is achieved with the current collector product according to claim 1.

According to a second aspect of the invention this objective is also achieved with the galvanic battery cell according to claim 11.

With the invention it has surprisingly been realised that iron or an iron alloy can be used as the material in a current collector for a Lithium or Sodium battery cell without adverse chemical degradation effects, thus making it a superior contender as the material in a current collector. By providing a galvanic, lithium or sodium battery cell with at least one current collector comprising a supporting portion supporting an electrode material attached thereon, and in which at least a part of the supporting portion is composed of iron or an iron alloy, it is achieved that the material of the current collector becomes both less expensive and is also light-weight.

A galvanic, lithium or sodium battery cell normally comprises a first electrode of a first electrode material providing a relative negative electrochemical potential, a second electrode of a second electrode material providing a relative positive electrochemical potential, and an electrolyte arranged between the electrodes and arranged to selectively allow transfer of lithium or sodium ions and to prevent transfer of electrons through the electrolyte. The galvanic battery cell normally also comprises one current collector associated with each electrode arranged to allow transfer of electrons between the current collector product and the electrode material. The current collectors are further adapted to be in electrical contact with respective electric poles of a battery, when assembled.

According to a preferred embodiment the supporting portion of the current collector product is adapted for attachment of an electrode material having a negative relative electrochemical potential thereon. Similarly, in a preferred embodiment of the galvanic battery cell, the supporting portion of the current collector comprising the part composed of iron or an iron alloy is arranged to support the negative electrode material. With the invention it has been realised that iron does not exhibit any of the prohibitively negative effects inherent with aluminium at the negative potential. By substituting the prior art current collector of copper with the new and inventive current collector comprising iron or an iron alloy at the negative electrode the poisonous nature of copper, as well as its high costs and high weight, is avoided. The iron material of the current collector for the negative electrode is thus both less expensive and simultaneously more environmentally friendly.

According to a preferred embodiment said part of the supporting portion of the current collector is composed of iron or an iron alloy having less than 10 percent by weight of impurities or alloying constituents. According to a preferred embodiment said part of the supporting portion of the current collector is composed of pure iron. Pure iron is both more malleable than an alloyed iron, resulting in better capabilities for shaping the current collector into desired shapes and allowing flexibility for the electrode, as well as providing a better electrical conductivity. Preferably, said part of the current collector is composed of pure iron with less than 4 percent by weight of impurities or alloying constituents. More preferably said part of the current collector is composed of pure iron with less than 3 percent by weight of impurities or alloying constituents. Even more preferably said part of the current collector is composed of pure iron with less than 2 percent by weight of impurities or alloying constituents, and most preferably less than 0.1 percent. In one embodiment the current collector is composed of pure iron with more than or equal to 0 percent by weight of impurities or allying constituents.

According to a preferred embodiment said part is composed of pure iron with less than 0.5 percent by weight of carbon. Preferably, said part is composed of pure iron with less than 0.3 percent by weight of carbon. More preferably said part is composed of pure iron with less than 0.1 percent by weight of carbon. Most preferably, said part of the current collector is composed of pure iron with less than 2 percent by weight of impurities or alloying constituents, simultaneously with less than 0.5 percent by weight of carbon. In one embodiment said part is composed of pure iron with more than or equal to 0 percent by weight of carbon. By using a pure iron the malleability needed to allow rolling from ingots or rods, or hot pressing from powder, to transform the current collector into a thin-film foil is obtained. In a preferred embodiment the pure iron comprises <2% of the elements Mn, Ni, Co, Cr, Mo, and comprises a carbon content<0.1% by weight. The impurities most likely to be present in iron are carbon, nickel, cobalt and manganese. In one embodiment the level of these impurities is equal to or more than 0% by weight. Preferably, the level of any other impurities, apart from the most common impurities of Mn, Ni, Co, Cr, Mo, and carbon, is below 0.1 percent by weight in total. In particular, the content of Al should be below 0.05 percent by weight, since Al incorporated in the iron may otherwise react with Li. In one embodiment the level of these other impurities is equal to or more than 0 percent by weight.

According to a preferred embodiment said supporting portion is shaped as a foil. A foil has a large surface area onto which the electrode material is attached allowing a high efficiency and power density for the battery cell. According to a preferred embodiment said supporting portion is shaped as a foil with a thickness less than or equal to 50 μm. Preferably, said supporting portion is shaped as a foil with a thickness less than or equal to 25 μm. Preferably, said supporting portion is shaped as a foil with a thickness greater than or equal to 1 μm. According to one embodiment the entire current collector is shaped as a foil. In a further embodiment a part of the current collector intended to be connect the current collector with the poles of a battery is also shaped as a foil.

According to one embodiment the battery cell comprises an electrochemical system in which lithium or sodium metal is deposited on the current collector. Preferably the battery is arranged with a Li-ion or Na-ion configuration in which the potential of the negative electrode is ≦+2.5 V vs. the reference of the alkali metal, Li° and Na°. According to one embodiment the positive electrode of a battery with the current collector of the invention comprises a redox-active material whose potential of operation is above 1.4 V vs. Li⁺:Li.

According to a preferred embodiment however the galvanic battery cell is a lithium-ion battery cell. A lithium-ion battery cell has a chemistry well adapted for a current collector comprising a supporting portion comprising a part composed of iron or an iron alloy.

According to one embodiment the negative electrode of batteries using the current collector of the invention comprises a redox-active material whose potential of operation is below 2.5 V vs. Li⁺:Li. Preferably, the negative electrode material comprises one or more of natural or artificial graphite which is pure or admixed with one or more of non-graphitic carbon, lithium terephthalate, Li₁₊ₓVO₂ (0≦x≦1), Li₄Ti₅O₁₂, Li_{3+y}FeN₂ (−1≦y≦1), Li₅₊ₓTiN₃ (0≦x≦1), or the three-phase mixture 2(1−z)LiH+(1−z)Mg+zMgH₂ (0≦z≦1). Preferably, the negative electrode material is an insertion type material, in which the Li or Na ions, respectively, are inserted into molecular channels or layers formed in the electrode material.

According to one embodiment the positive electrode of batteries using the current collector of the invention for the negative current collector comprises a redox-active material whose potential of operation is above 1.4 V vs. Li⁺:Li. Preferably, the positive electrode material comprises one or more of layered oxide LiₓM¹O₂(M¹=Co, Ni, Mn) or spinel LiₓMn₂O₄, where in both cases a fraction of less than 15% of the atoms of the transition elements can be replaced by Al, Mg, or Li; LiₓNi_{0.5}Mn_{1.5}O₄; phosphate LiₓM²PO₄ (M²=Fe, Mn), where a fraction of less than 10% of the atoms of the transition elements can be replaced by Mg, Na or Y; fluorophosphates Li₁₊ₓFePO₄F or LiₓFePO₃F₂, or fluorosulfate LiₓFeSO₄F, where in all cases (0≦x≦1), or mixtures thereof. Preferably, the positive electrode material is an insertion type material, in which the Li or Na, respectively, are inserted into molecular channels or layers formed in the electrode material. Preferably, both the positive and the negative electrode materials are insertion materials, wherein the battery is provided with a structure which in the literature is referred to as a rocking chair battery cell.

According to one embodiment the battery using the current collector of the invention includes an electrolyte formed from a salt dissolved in a solvent, liquid, gel, or polymer. Preferably the salt comprises one or more of LiPF₆, LiBF₄, Li[CF₃SO₃], Li[CF₃BF₃], Li[C₂F₅BF₃], Li[C(CN)₃], Li[CF₃COC(CN)₂], Li[CF₃SO₂C(CN)₂], 2-trifluoromethyl-4,5-dicyanoimidazole, 2-trifluoroethyl-4,5-dicyanoimidazole, Li[R_{f}SO₂NSO₂R_{f}] with R_{f}═F, CF₃, C₂F₅, C₄F₉, or C₆F₁₃, or mixtures thereof. According to one embodiment the electrolyte comprises a solvent comprising one or more organic carbonates. Preferably the one or more organic carbonates are selected from alicyclic or cyclic carbonates, such as ethylene and propylene carbonate; amides and ureas including dimethyl formamide, N-methylpyrrolidinone, N-ethyl-pyrrolidinone, 1,3-dimethyl-2-imidazolidinone, 1,3-dimethyl-3,4,5,6-tetrahydro-2(1H)-pyrimidinone, dimethyl and diethyl cyanamide; dimethyl sulfoxide; dimethylsulfone; γ-butyrolactone; or mixtures thereof.

According to one embodiment the electrolyte also comprises a gelling agent. Preferably, the gelling agent is a polymer, such as a common polymer. More preferably, the gelling agent is a solvating polymer. According to one embodiment the gelling agent is selected from the group consisting of: polyvinylidene fluoride, its copolymers with hexafluoropropene, poly(alkyl)acrylate, poly(alkyl)methacrylate, polyacrylonitrile, poly(ethylene oxide), polymers having more than 60% and less than or equal to 100% of their repeat units consisting of the —CH₂CH₂O— sequence, and mixtures thereof.

According to one embodiment the electrolyte comprises an additive forming a protective layer on the relative negative electrochemical electrode, the additive being chosen from vinylene carbonate, vinyl-ethylene carbonate, fluoro-ethylene carbonate, fluoromethyl-ethlylene carbonate, bis(trifluoroethyl)-carbonate, and mixtures thereof.

According to one embodiment the current collector product comprises a roll of an iron or iron alloy foil. A roll is easy to transport and it is easy to punch or cut the foil forming the roll into the desired shapes for the final current collectors, or to incorporate it immediately without a shaping step into battery cells. In one embodiment the current collector product comprises a roll of a single layer foil of iron or iron alloy. In one embodiment the current collector product comprises a roll of an iron or iron alloy foil laminated with a layer of copper or copper alloy. In one embodiment the current collector product comprises a roll of an iron or iron alloy foil laminated with a foil of aluminium or aluminium alloy. In this case the layer of iron or iron alloy foil is arranged to make contact with the negative electrode material. In yet another embodiment the current collector product comprises a roll of an iron or iron alloy foil laminated with a foil of aluminium or aluminium alloy and simultaneously also laminated with at least one layer of copper or copper alloy.

According to a third aspect the objective of the invention is also achieved with the method for producing a current collector product according to claim 25. According to one embodiment of the third aspect of the invention a current collector product adapted for transfer of electrons between the current collector and the electrode material is produced by forming a current collector product comprising a supporting portion for supporting an electrode material thereon by forming at least a part of the supporting portion from iron or an iron alloy. Thus the advantages as indicated previously in relation to aspects 1 and 2 are achieved.

According to a preferred embodiment the current collector product is produced by forming a current collector product shaped as a foil. Preferably the method also comprises forming the current collector product in the form of an iron foil having a thickness less than or equal to 50 μm in total. Preferably the method also comprises forming the current collector product in the form of an iron foil having a thickness greater than or equal to 1 μm in total. According to one embodiment the method comprises forming the current collector product by co-laminating an iron foil with a layer of copper and/or aluminium.

According to one embodiment the current collector product is formed by rolling the current collector product into a foil from an ingot or rod. In an alternative embodiment the current collector product is formed by electrochemical plating from a liquid bath containing iron salts.

According to a preferred embodiment however, the current collector product is produced from an iron powder. Preferably the method also comprises heating the powder to form an integrated product in the form of a current collector comprising a supporting portion comprising an iron or iron alloy part. In one embodiment the method comprises forming a current collector product from an iron powder, wherein the method further comprises one or more of casting, pressing and/or sintering the iron powder. According to one embodiment the current collector product is formed by hot pressing the current collector product into a foil from a metal powder, preferably a pure iron powder.

In one embodiment the formation of the current collector product from a powder comprises forming the current collector product by casting an iron powder onto an inert support. Preferably the method comprises doctor blading the iron powder onto the support to form a thin and even layer of powder. Alternatively, or in combination, the method also comprises pressing the iron powder by rolling.

In a preferred embodiment the heating of the powder comprises forming the current collector product by sintering an iron powder at a temperature between −50° C. and 900° C. In one alternative the heating may be carried out in an oven. In another alternative the heating may be carried out by scanning the iron powder with a laser beam to sinter the iron powder. In another embodiment the heating may be carried out by a flame or plasma process, where an iron powder is melted and projected onto a cold surface. Alternatively one or more combinations of these alternatives may be carried out.

### BRIEF DESCRIPTION OF THE DRAWINGS

The invention is now to be described as a number of non-limiting examples of the invention and with reference to the attached drawings.

FIGS. 1a-b shows one example of a battery cell and its interior according to one aspect of the invention.

FIGS. 2a-f shows different examples of current collector products according to the invention.

FIG. 3 shows a method for producing a current collector product.

FIG. 4 shows experimental results from comparing the cycling of graphite on an iron current collector versus on a corresponding copper current collector.

### DETAILED DESCRIPTION

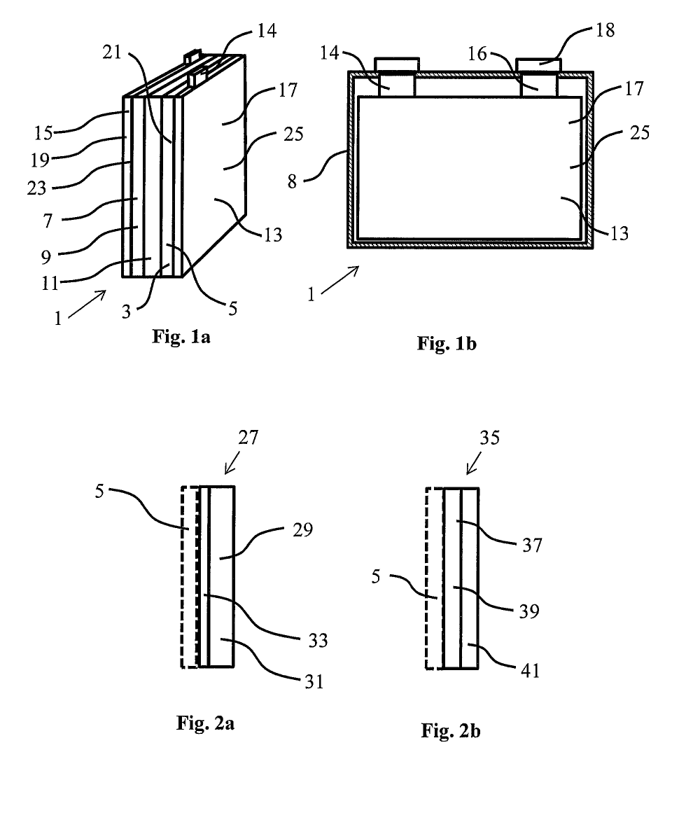

In FIGS. 1a-b one example of a galvanic battery cell 1 according to the invention is shown. In this example the battery cell 1 is a lithium or sodium battery cell comprising a first electrode 3 of a first electrode material 5 providing a negative electrochemical potential, a second electrode 7 of a second electrode material 9 providing a positive electrochemical potential, an electrolyte 11 arranged between the electrodes and arranged to selectively allow transfer of lithium or sodium ions and to prevent transfer of electrons through the electrolyte, and a first 13 and second 15 current collectors one for each electrode, comprising a supporting portion 17, 19 supporting the respective first 5 and second 9 electrode materials, which electrode materials are attached thereon to allow transfer of electrons between the current collector product and the electrode material. In this example the first and second electrode materials are arranged in direct contact with at least one surface 21, 23 of the current collectors. The current collectors are arranged as supports for the electrode materials, and are also arranged as electrical connectors between the respective electrode materials and the electric poles 18 of the battery cell 1. The current collectors are for this purpose in this example provided with connecting tabs 14, 16 arranged to make electrical contact with the poles 18 of the battery cell. The electric poles of the battery cell are in turn intended to be electrically connected to each other via an external circuit, wherein the battery cell provides energy in case the external circuit contains a load, and is charged with energy in case the external circuit provides a charging current. The direction of electron transfer between the current collectors and the respective electrodes depends on whether the battery cell is currently being discharged or charged. In FIG. 1b the galvanic battery cell 1 is also shown comprising a housing 8 inside which the electrode materials, the electrolyte and the current collectors are arranged.

In this example at least a part 25 of the supporting portion 17 of the first current collector 13, in this example the current collector associated with the electrode with negative electric potential, is composed of iron or an iron alloy. Thus the advantages as stated in the general section above are achieved. In this example said part 25 composed of iron or an iron alloy is arranged in contact with the first electrode material 5 having a negative electric potential relative to Li+:Li⁰. In this example said part of the supporting portion 17 of the first current collector 13 is composed of pure iron with less than 2 percent by weight of impurities or alloying constituents, such as Mn, Ni, Co, Cr, or Mo, simultaneously with less than 0.5 percent by weight of carbon.

The supporting portion 17 of the first current collector 13 is in this example shaped as a foil. In this example the entire first current collector 13 is shaped as a foil of iron or iron alloy. The thickness of the foil is less than or equal to 50 μm, in this example less than or equal to 25 μm and greater than or equal to 1 μm. The first electrode material 5 of the first electrode 3 is further attached onto the supporting portion 17 forming a flat layer onto the foil. In this example the entire first current collector 13 is composed of said iron material. Thus the part 25 of iron or iron alloy is arranged to allow the transfer of electrons between the current collector and the electrode material.

The second current collector 15 associated with the second electrode 7 with positive electric potential, is in this example composed of aluminium or an aluminium alloy. However, in another example, the second current collector could in principle also be composed of iron. The second current collector 15 is similarly shaped as a foil, and the second electrode material is attached onto the supporting portion 19 of the second current collector forming a flat layer onto the foil. Thus it is easy to form battery cells 1 of different shapes, such as a cylindrical battery by rolling together the sheets of current collectors/electrodes and disposing the electrolyte 11 in-between, or a flat battery as shown in FIG. 1a, by stacking the sheets of current collectors/electrodes and disposing the electrolyte in-between.

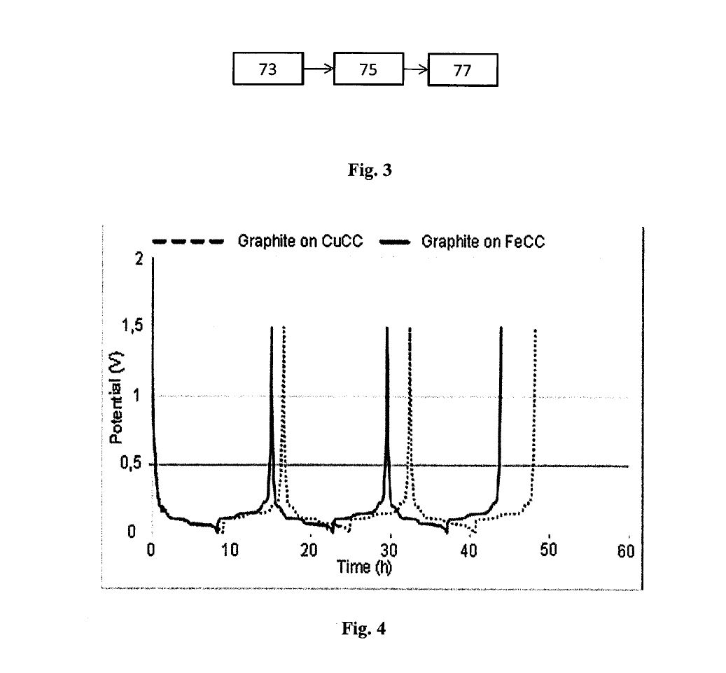

The materials 5, 9 forming the negative and positive electrodes, as well as the material forming the electrolyte 11, may be selected from materials known in the art to be suitable for forming Lithium and/or Sodium batteries. The electrode materials are materials allowing an electrochemical reaction in the galvanic cell for the production or storage of electric energy in chemical form. For example materials suitable for forming a negative electrode material may comprise, but is not limited to, graphite, silicon and tin. Preferably however, the electrode material is graphite. Alternatively, and preferably, the materials forming the negative and positive electrodes, as well as the material forming the electrolyte in the battery cell in FIG. 1 may be selected from the materials as described in the method for producing a battery cell according to the invention as described in conjunction with FIG. 3 below.

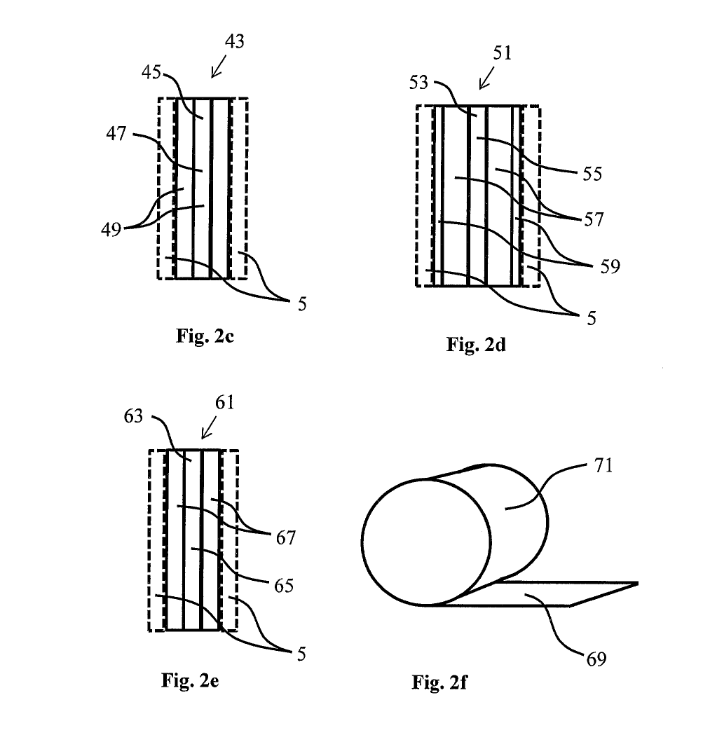

In FIG. 2a-d alternative examples of current collector products according to the invention are shown, which could be used as substitutes for the first current collector 13 and thus be incorporated into the battery cell shown in FIG. 1.

The current collector product 27 in FIG. 2a comprises a supporting portion 29 comprising a part 31 composed of iron or an iron alloy, and also a thin layer 33 of copper or copper alloy formed on the iron or iron alloy part. In this example the supporting portion 29 is foil-shaped, comprising a foil of iron or iron alloy and with the layer 33 of copper or copper alloy formed onto the iron or iron alloy foil. The thin layer of copper or copper alloy is in this example intended to be in contact with the electrode material 5. The electrode material is then attached onto the thin layer 33 of copper or copper alloy. Thus a good electrical conductivity between the electrode material 5 and the current collector product 27 is obtained.

The thin layer 33 of copper or copper alloy is in one alternative co-laminated onto the part of the supporting portion composed of iron or iron alloy. In another alternative the layer 33 of copper or copper alloy is electrodeposited onto the part of the supporting portion composed of iron or iron alloy. In yet another alternative the layer 33 of copper or copper alloy is deposited onto the part 31 of the supporting portion composed of iron or iron alloy by electroless deposition. The copper or copper alloy is preferably selected from electrical grade copper or copper alloys or a copper or copper alloy having higher purity.

In FIG. 2b yet another example of a current collector product 35 according to the invention is shown. The current collector in FIG. 2b comprises a supporting portion 37 comprising a part 39 composed of iron or an iron alloy laminated with an aluminium or aluminium alloy foil 41. In this example the part 39 of iron or iron alloy is also shaped as a foil and is arranged to face and to make contact with the electrode material 5, while the aluminium foil 41 is arranged shielded from direct contact with the electrode material and from the electrolyte by the iron foil 39. Thus the advantage of chemical compatibility of iron is combined with the material advantage of aluminium with low weight and high electrical conductivity. The aluminium or aluminium alloy is preferably selected from electrical grade aluminium or aluminium alloys or an aluminium or aluminium alloy having higher purity.

In FIG. 2c a current collector product 43 comprising a supporting portion 45 comprising an aluminium or aluminium alloy foil 47 sandwiched between two iron or iron alloy foils 49 is shown. The two parts 49 comprising the iron or iron alloy are arranged to face and to make contact with electrode materials 5 arranged on either side of the current collector product, while the aluminium foil 47 is arranged shielded from direct contact with the electrode materials 5 and from the electrolyte by the iron foils 49. Thus the aluminium or aluminium alloy foil will be shielded in two directions from the negative electrode material arranged on both sides of the current collector and the electrolyte, so that the current collector in FIG. 2c can be used in a battery cell with several parallel layers of electrodes without risk of degradation at the negative potential.

In FIG. 2d a current collector product 51 comprises a supporting portion 53 comprising an aluminium or aluminium alloy foil 55 sandwiched between two iron or iron alloy foils 57 and further comprising two layers 59 of copper or copper alloy formed onto the iron or iron alloy foils is shown. In this example the copper or copper alloy layers 59 are arranged to face the electrode materials 5 to ensure a good electrical connection, while the aluminium or aluminium alloy foil 55 is arranged shielded from direct contact with the electrode material and from the electrolyte by the iron or iron alloy foils 57.

In FIG. 2e a current collector product 61 comprises a supporting portion 63 comprising a copper or copper alloy foil 65 sandwiched between two iron or iron alloy foils 67 is shown. The iron or iron alloy foils 67 are in this example intended to be in contact with electrode materials 5 formed on each side of the supporting portion 63. The copper or copper alloy foil 65 gives the current collector 61 a high electric conductivity, while the iron or iron alloy foils 67 gives chemical stability.

In FIG. 2f a current collector product 69 is shown comprising a roll 71 of an iron or iron alloy foil. In this example the thickness of the iron or iron alloy foil is less than or equal to 50 μm. A roll 71 of iron or iron alloy foil is a convenient way of storing an iron or iron alloy foil, which foil may then subsequently be shaped, cut or otherwise be adapted to form one or more current collectors in one or more galvanic battery cells. The foil of the roll may thus be incorporated into a plurality of separate galvanic battery cells. In alternative embodiments the roll may instead comprise a laminated foil having one of the configurations as described in relation to FIGS. 2a-e.

In FIG. 3 different methods for producing a current collector product are shown in steps 73 and 75, and different methods for producing a battery cell incorporating a current collector product according to the invention are shown in step 77.

In step 73 the method comprises producing a current collector product comprising a supporting portion for supporting an electrode material thereon by forming at least a part of the supporting portion from iron or an iron alloy. In this example the method comprises forming a current collector product comprising an iron or iron alloy foil. The iron or iron alloy foil is in one alternative produced by rolling an iron or an iron alloy ingot or rod. In another alternative the iron or iron alloy foil is produced by hot-pressing or sintering a metal sheet from iron powder. In one embodiment the iron powder particles are cast or doctor-bladed onto an inert support, with or without a solvent, and then sintered by the application of high temperature, with or without pressure. In a preferred embodiment the pressure is applied in particular between rollers and the iron sheet is separated from the inert support. In another embodiment, the pressed powders are free-standing and are rolled/pressed/sintered directly. In another, alternative embodiment the iron or iron alloy foil is produced from iron powder in a flame or plasma process, where the metal powder is molten projected onto a colder surface directly to make a film. The powder deposited on a substrate or free-standing film can be scanned with a laser beam to melt locally and similarly make a film.

In a variation of the embodiment of the invention, rather than rolling or hot pressing, the iron is deposited directly by electrowinning from a solution of ferrous or ferric salts in aqueous or non-aqueous solutions. Suitable solvents, besides water, are alcohols, cyclic carbonates, amides and ureas, including propylene carbonate and dimethyl formamide, N-methylpyrrolidinone, N-ethyl-pyrrolidinone 1,3-dimethyl-2-imidazolidinone, 1,3-dimethyl-3,4,5,6-tetrahydro-2(1H)-pyrimidinone, dimethyl and diethyl cyanamide. Another family of solvents for electrowinning the metal are the so-called ionic liquids, i.e., the combination of an “onium” type cation and a highly charge-delocalised negative charge. Typical examples include imidazoliums, pyrrolidiniums, quaternary ammoniums and phosphoniums as cations, and triflate CF₃SO₃⁻ or bis(trifluoromethanesulfonimide)—TFSI—(CF₃SO₂)N⁻ as anions. The advantage of ionic liquids is their absence of vapour pressure, thus allowing the plating operation to take place above room temperature, where the conductivity is higher and the crystal grain-growth can be better controlled. In yet another alternative the current collector product is obtained by electrochemical plating from a liquid bath, such as an aqueous or non-aqueous bath, containing iron, preferably in the form of an iron salt.

The preferred thicknesses of the metal foils, whichever of the above-mentioned processes is put into practice, are between 50 and 1 micrometers, preferably between 25 and 1 micrometers. The impurities most likely to be present are carbon, nickel, cobalt and manganese.

In an optional step 75 the iron or iron alloy foil is processed further to include additional material layers to the current collector. In one embodiment of the invention, the iron is co-laminated with aluminium, so that at least one of the aluminium surfaces is covered by a layer of iron impervious to the electrolyte used in the electrochemical cell. An Al/Fe bilayer is formed when a bipolar configuration is used, while a trilayer Fe/Al/Fe is formed when a coating of the same negative electrode material is used on both sides for bifacial construction. The co-lamination can be performed also by pressing iron powder onto aluminium foil.

In an alternative embodiment the method comprises covering the iron current collector with a thin layer of copper. This improves the conductivity, but corresponds to a negligible consumption of copper. The layer of copper can be obtained by co-lamination, electrolytic deposition, or electroless deposition in aqueous or non-aqueous copper salt solutions.

In another embodiment it is an object of the invention to include besides foils, patterned metal as porous felt, expanded metal obtained by slitting and cold-drawing of the foils. Here again iron powder is used as a base for making the current collectors of the invention.

In a method for also forming a battery cell from the current collector product, the method additionally comprises in step 77 forming a negative electrode onto a surface of the current collector product. The negative electrode of batteries using the current collector of the invention comprises all redox-active materials whose potential of operation is below 2.5 V vs. Li⁺:Li⁰; this includes, but is not limited to: graphite (natural or artificial)—pure or admixed with non-graphitic carbon, lithium terephthalate, Li₁₊ₓVO₂ (0≦x≦1), Li₄Ti₅O₁₂, Li_{3+y}FeN₂ (−1≦x≦1), Li₅₊ₓTiN₃ (0≦x≦1), the three-phase mixture 2(1−z)LiH+(1−z)Mg+zMgH₂ (0≦z≦1).

In step 77, the method may also comprise forming a positive electrode for the battery cell.

The positive electrode of batteries also incorporating the current collector of the invention for the negative current collector comprises all redox-active material whose potential of operation is above 1.4 V vs. Li⁺:Li⁰. This includes, but is not limited to: layered oxides LiₓM¹O₂ (M¹=Co, Ni, Mn) or a spinel LiₓMn₂O₄, where in both cases a fraction (<15% and >0%) of the transition elements can be replaced by Al, Mg or Li; a phosphate LiₓM²PO₄ (M²=Fe, Mn), where a fraction (<10% and >0%) of the transition elements can be replaced by Mg, Na or Y, a fluorophosphate Li₁₊ₓFePO₄F, or LiₓFePO₃F₂, a fluorosulfate LiₓFeSO₄F, where in all cases (0≦x≦1), and mixtures thereof.

In step 77, the method may also comprise forming an electrolyte for the battery cell. The battery using current collectors of the invention includes an electrolyte formed from a salt dissolved in a solvent, liquid, gel, or polymer. This includes, but is not limited to, organic carbonates, alicyclic or cyclic like ethylene and propylene carbonate, amides and ureas including dimethyl formamide, N-methylpyrrolidinone, N-ethyl-pyrrolidinone 1,3-dimethyl-2-imidazolidinone, 1,3-dimethyl-3,4,5,6-tetrahydro-2(1H)-pyrimidinone, dimethyl and diethyl cyanamide, dimethyl sulfoxide, dimethylsulfone, gamma-butyrolactone; the gelling agent being chosen among the common polymers, polyvinylidene fluoride, its copolymers with hexafluoropropene, poly(alkyl)acrylate, poly(alkyl)methacrylate, polyacrylonitrile; solvating polymers like poly(ethylene oxide), or in general polymers having more than 60% of their repeat units consisting of the —CH₂CH₂O— sequence.

The salt dissolved in the electrolyte is preferably, but not limitatively, chosen among LiPF₆, LiBF₄, Li[CF₃SO₃], Li[CF₃BF₃], Li[C₂F₅BF₃], Li[R_{f}SO₂NSO₂R_{f}] with R_{f}═F, CF₃, C₂F₅, C₄F₉, C₆F₁₃, Li[C(CN)₃], Li[CF₃COC(CN)₂], Li[CF₃SO₂C(CN)₂], 2-trifluoromethyl-4,5-dicyanoimidazole, 2-trifluoroethyl-4,5-dicyanoimidazole and mixtures thereof.

An additive, beneficially added to the electrolyte to form a protective layer on the negative electrode, is chosen in preference but not limitingly among vinylene carbonate, vinyl-ethylene carbonate, fluoro-ethylene carbonate, fluoromethyl-ethlylene carbonate, bis(trifluoroethyl)-carbonate and mixtures thereof.

In FIG. 4 one example of an experiment comparing an iron current collector with a copper current collector is shown, in which the current collectors supports an electrode material of graphite intended to act as a negative electrode.

### EXAMPLES

An experimental battery is built with the following characteristics:

Lithium-foil counter electrode
Working graphite electrode on either Cu (state-of-the-art) or 99.95% pure Fe metal current collector
Glass fiber separator
1M LiPF₆ EC:DEC 2:1 as solvent
Cut-out tab for current extraction/injection
C/10 charge/discharge rate

The results upon cycling are shown in FIG. 4.

The figure shows the experimental results from comparing the potential obtained when cycling graphite vs. Li⁺/Li⁰ with an iron current collector and a corresponding copper current collector, respectively. As can be seen, the comparison of the potential cycling shows that the iron current collector of the invention has comparable capacity and capacity retention as copper upon cycling, and are at most 10% less. However, FIG. 4 actually shows the worst-case example obtained from a plurality of experiments made by the inventors, and for some samples the capacity and capacity retention for iron were higher than the capacity and capacity retention for copper. The differences in total capacity for different samples are believed to be mainly due to fluctuations during the coating process, and the difficulty to obtain even electrode layers.

The invention is not limited to the examples shown but may be varied freely within the framework of the following claims. In particular, a man skilled in the art appreciates that the various configurations and features shown in the examples of the description and drawings may be freely combined with each other, giving rise to new combinations, without departing from the scope of the invention.

1. A current collector product for one or more galvanic battery cells, wherein the current collector product is adapted to be incorporated into one or more lithium or sodium battery cell(s) and comprises at least one supporting portion adapted for supporting an electrode material thereon to allow transfer of electrons between the current collector product and the electrode material, characterized in that at least a part of the supporting portion is composed of pure iron or an iron alloy with less than 10 percent by weight of impurities or alloying constituents.

2. A current collector product according to claim 1, characterized in that said part is composed of pure iron with less than 2 percent by weight of impurities or alloying constituents.

3. A current collector product according to claim 1, characterized in that said part is composed of pure iron with less than 0.1 percent by weight of carbon.

4. A current collector product according to claim 1, characterized in that said supporting portion is shaped as a foil with a thickness less than or equal to 50 μm, preferably less than or equal to 25 μm.

5. A current collector product according to claim 1, characterized in that said supporting portion comprises a thin layer of copper or copper alloy arranged to be in contact with the electrode material.

6. A current collector product according to claim 1, characterized in that said iron or iron alloy part is arranged to be in contact with the electrode material.

7. A current collector product according to claim 1, characterized in that said supporting portion comprises an iron or iron alloy foil laminated with an aluminium or aluminium alloy foil.

8. A current collector product according to claim 7, characterized in that said supporting portion comprises an aluminium or aluminium alloy foil sandwiched between two iron or iron alloy foils.

9. A current collector product according to claim 1, characterized in that the supporting portion is adapted to be associated with an electrode material having a negative electrochemical potential.

10. A current collector product according to claim 1, characterized in that the current collector product comprises a roll of an iron or iron alloy foil.

11. A galvanic, lithium or sodium battery cell comprising a first electrode of a first electrode material providing a negative electrochemical potential, a second electrode of a second electrode material providing a positive electrochemical potential, an electrolyte arranged between the electrodes and arranged to selectively allow transfer of lithium or sodium ions and to prevent transfer of electrons through the electrolyte, and at least one current collector comprising a supporting portion supporting an electrode material attached thereon to allow transfer of electrons between the current collector and the electrode material, characterized in that at least a part of the supporting portion is composed of pure iron or an iron alloy with less than 10 percent by weight of impurities or alloying constituents.

12. A galvanic, lithium or sodium battery cell according to claim 11, characterized in that said part is composed of pure iron with less than 2 percent by weight of impurities.

13. A galvanic, lithium or sodium battery cell according to claim 11, characterized in that said part is composed of pure iron with less than 0.1 percent by weight of carbon.

14. A galvanic, lithium or sodium battery cell according to claim 11, characterized in that the supporting portion is shaped as a foil with a thickness less than or equal to 50 μm.

15. A galvanic, lithium or sodium battery cell according to claim 11, characterized in that the supporting portion comprises a thin layer of copper or copper alloy arranged in contact with the electrode material.

16. A galvanic lithium or sodium battery cell according to claim 11, characterized in that said iron or iron alloy part is arranged in contact with the electrode material.

17. A galvanic lithium or sodium battery cell according to claim 11, characterized in that said supporting portion comprises an iron or iron alloy foil laminated with an aluminium or aluminium alloy foil.

18. A galvanic, lithium or sodium battery cell according to claim 11, characterized in that said supporting portion comprises an aluminium or aluminium alloy foil sandwiched between two iron or iron alloy foils.

19. A galvanic, lithium or sodium battery cell according to claim 11, characterized in that the negative electrode material comprises one or more of:
natural or artificial graphite which is pure or admixed with one or more of non-graphitic carbon, lithium terephthalate, Li₁₊ₓVO₂ (0≦x≦1), Li₄Ti₅O₁₂, Li_{3+y}FeN₂ (−1≦y≦1), Li₅₊ₓTiN₃ (0≦x≦1), or the three-phase mixture 2(1−z)LiH+(1−z)Mg+zMgH₂ (0≦z≦1).

20. A lithium or sodium battery cell according to claim 11, characterized in that the positive electrode material comprises one or more of:
layered oxide LiₓM¹O₂ (M¹=Co, Ni, Mn) or spinel LiₓMn₂O₄, where in both cases a fraction of less than 15% by weight of the transition elements can be replaced by Al, Mg, or Li; LiₓNi_{0.5}Mn_{1.5}O₄; phosphate LiₓM²PO₄ (M²=Fe, Mn), where a fraction of less than 10% by weight of the transition elements can be replaced by Mg, Na or Y; fluorophosphates Li₁₊ₓFePO₄F or LiₓFePO₃F₂; or fluorosulfate LiₓFeSO₄F, where in all cases (0≦x≦1); or mixtures thereof.

21. A galvanic, lithium or sodium battery cell according to claim 11, characterized in that the electrolyte comprises a salt dissolved in a solvent, liquid, gel, or polymer, wherein the salt comprises one or more of:
LiPF₆, LiBF₄, Li[CF₃SO₃], Li[CF₃BF₃], Li[C₂F₆BF₃], Li[C(CN)₃], Li[CF₃COC(CN)₂], Li[CF₃SO₂C(CN)₂], 2-trifluoromethyl-4,5-dicyanoimidazole, 2-trifluoroethyl-4,5-dicyanoimidazole, Li[R_{f}SO₂NSO₂R_{f}] with R_{f}═F, CF₃, C₂F₅, C₄F₉, or C₆F₁₃, or mixtures thereof.

22. A galvanic, lithium or sodium battery cell according to claim 21, characterized in that the electrolyte comprises a solvent comprising one or more organic carbonates selected from:
alicyclic or cyclic carbonates, such as ethylene and propylene carbonate; amides and ureas including dimethyl formamide, N-methylpyrrolidinone, N-ethyl-pyrrolidinone, 1,3-dimethyl-2-imidazolidinone, 1,3-dimethyl-3,4,5,6-tetrahydro-2(1H)-pyrimidinone, dimethyl and diethyl-cyanamide; dimethyl sulfoxide; dimethylsulfone; γ-butyrolactone;
and further comprising a gelling agent selected from:
polyvinylidene fluoride, its copolymers with hexafluoropropene, poly(alkyl)acrylate, poly(alkyl)methacrylate, or polyacrylonitrile; solvating polymers like poly(ethylene oxide); polymers having more than 60% of their repeat units consisting of the —CH₂CH₂O— sequence; or mixtures thereof.

23. A galvanic, lithium or sodium battery cell according to claim 11, characterized in that the electrolyte comprises an additive forming a protective layer on the relative negative electrochemical electrode, the additive being chosen from vinylene carbonate, vinyl-ethylene carbonate, fluoro-ethylene carbonate, fluoromethyl-ethlylene carbonate, bis(trifluoroethyl)-carbonate and mixtures thereof.

24. A galvanic, lithium or sodium battery cell according to claim 11, characterized in that the galvanic battery cell is a lithium-ion battery cell.

25. A method for producing a current collector product for one or more galvanic, lithium or sodium battery cell(s), the current collector product being adapted to have an electrode material attached thereon for transfer of electrons between the current collector and the electrode material, characterized in that the method comprises the step
forming a current collector product comprising a supporting portion for supporting an electrode material thereon by forming at least a part of the supporting portion from pure iron or an iron alloy with less than 10 percent by weight of impurities or alloying constituents.

26. A method for producing a current collector product according to claim 25, characterized in that the method comprises:
forming a current collector product from an iron powder, wherein the method further comprises one or more of casting, pressing and/or sintering the iron powder.

27. A method for producing a current collector product according to claim 25, characterized in that the method comprises
forming a current collector product from an iron powder, wherein the method further comprises one or more of casting, pressing and/or sintering the iron powder; and
forming the current collector product by casting an iron powder onto an inert support.

28. A method for producing a current collector product according to claim 27, characterized in that the method further comprises doctor blading the iron powder on the support to form a thin and even layer of powder.

29. A method for producing a current collector product according to claim 26, characterized in that the method comprises pressing the iron powder by rolling.

30. A method for producing a current collector product according to claim 26, characterized in that the method comprises
forming the current collector product by sintering an iron powder at a temperature between −50° C. and 900° C.

31. A method for producing a current collector product according to claim 26, characterized in that the method comprises scanning the iron powder with a laser beam to sinter the iron powder.

32. A method for producing a current collector product according to claim 25, characterized in that the method comprises forming the current collector product by a flame or plasma process, where an iron powder is melted and projected onto a cold surface.

33. A method for producing a current collector product according to claim 25, characterized in that the method comprises forming the current collector product by electrochemical plating from a liquid bath containing iron salts.

34. A method for producing a current collector product according to claim 25, characterized in that the method comprises forming the current collector product by co-laminating an iron foil with a layer of copper and/or aluminium.

35. A method for producing a current collector product according to claim 25, characterized in that the method comprises forming a current collector product in the form of an iron foil having a thickness less than or equal to 50 μm.
